(19) United States
(12) Patent Application Publication
(10) Pub. No.: US 2006/0196023 A1
(43) Pub. Date: Sep. 7, 2006

(54) Reduced cost process modules

(76) Inventor: Min-Lyul Lee, Suwon-City (KR)

Correspondence Address: PERMAN & GREEN, 425 POST ROAD, FAIRFIELD, CT, 06824, US

(21) Appl. No.: 11/070,443

(22) Filed: Mar. 2, 2005

(51) Int. Cl. B21D 33/00; B32B 37/00

(52) U.S. Cl. 29/17.3

(57) ABSTRACT

A process module and a method of making the same for processing substrates comprising two different types of materials, one of the materials being a corrosive-retardant material forming a module interior face disposed to be subjected to the interior atmosphere in the module, and another of the materials being located on the side of the corrosive-retardant material to define a module outer face opposite the interior face, wherein the corrosive-retardant material and the other material are joined together.

### BACKGROUND

1. Field of Invention

The present invention relates to process modules used for manufacturing semiconductor substrates and, more particularly, to reduced cost process modules and module parts.

2. Brief Description of Related Developments

The manufacturing of semi-conductor substrates such as wafers and panels is generally carried out in systems whereby the substrate is sequentially transported into and out of one or more process modules by a substrate transport apparatus such as a transport robot. In one embodiment of this system, the transport robot is located adjacent one or more process modules wherein various phases of the manufacturing process is carried out. The process modules can provide a variety of functions including a path of transport into, through and out of the system as well as chemical and physical processing to the substrate. Such process modules include load lock and load port modules and process chambers which can carry out heating, cleaning, etching, sputtering, depositing layers on the substrate such as through chemical vapor deposition, etc. Many of the process modules contain corrosive environments due to the use of reactive gases such as halogen, oxygen, plasmas, etc. in the system. The process modules should be made to withstand this harsh environment. Corrosion of metal components in the process modules limits the life of the modules and increases the down time of the manufacturing process and consequently its cost.

Aluminum and aluminum alloys are widely used as material for the inner component parts of a process module such as walls, bottoms, ceilings, substrate supports, internal portions of gas distributors, gas exhausts, gas inlets, etc. This is because aluminum provides good protection against corrosion. However, as the size of the process modules has had to increase because of the ever-increasing demand for larger sizes of substrates being processed, e.g., the flat panel substrates that are now widely in production, the cost of making the process modules and their components out of aluminum is growing more expensive due to both increased material cost as well as the limitation in the availability of material stock of sufficient size to allow fabrication of the larger modules. Although adaptable to any aspect of semi-conductor equipment, the improvement is especially useful to such equipment wherein reducing the cost of the process module and its component parts is desirable such as when processing large substrates.

### SUMMARY OF THE EXEMPLARY EMBODIMENTS

In accordance with an exemplary embodiment, a process module for processing substrates comprising two different types of materials, one of the materials being a corrosive-retardant material forming a module interior face disposed to be subjected to the interior atmosphere in the module, and another of the materials being located on the side of the corrosive-retardant material to define a module outer face opposite the interior face, wherein the corrosive-retardant material and the other material are joined together.

In one embodiment, the component part(s) is used in a process module of an apparatus for processing substrates comprising a module having two different types of materials, a corrosive-retardant material facing the substrate when in the module and a second adjacent material located on the side of the corrosive-retardant material opposite that facing the substrate when in the module, the corrosive retardant material and the second material being joined together whereby the amount of corrosive-retardant material can be reduced.

In another embodiment, there is disclosed a method of making a part(s) for a process module used in processing substrates in a corrosive environment comprising providing a first corrosive retardant material, joining a second material to the corrosive retardant material.

### BRIEF DESCRIPTION OF THE DRAWINGS

The foregoing aspects and other features of the improvement are explained in the following description, taken in connection with the accompanying drawings, where:

FIG. 1 is a schematic perspective view of a substrate processing apparatus, incorporating the features of the improvement herein in accordance with one exemplary embodiment;

FIG. 2 is a schematic illustration of a process module of the apparatus in FIG. 1;

FIG. 3 is a schematic illustration of a second module of the apparatus in FIG. 1;

FIG. 4a is a perspective view of a component part of the module in FIG. 1

FIG. 4b is a cross-section view taken through line 4—4 in FIG. 4a;

FIG. 5a is a perspective view of a component part of the module in FIG. 3;

FIG. 5b is a cross-section view taken through line 5—5 of FIG. 5a; and

FIG. 6 is a schematic plan view of a substrate processing apparatus, incorporating the features of the improvement herein in accordance with another exemplary embodiment.

### DETAILED DESCRIPTION OF THE EXEMPLARY EMBODIMENT(S)

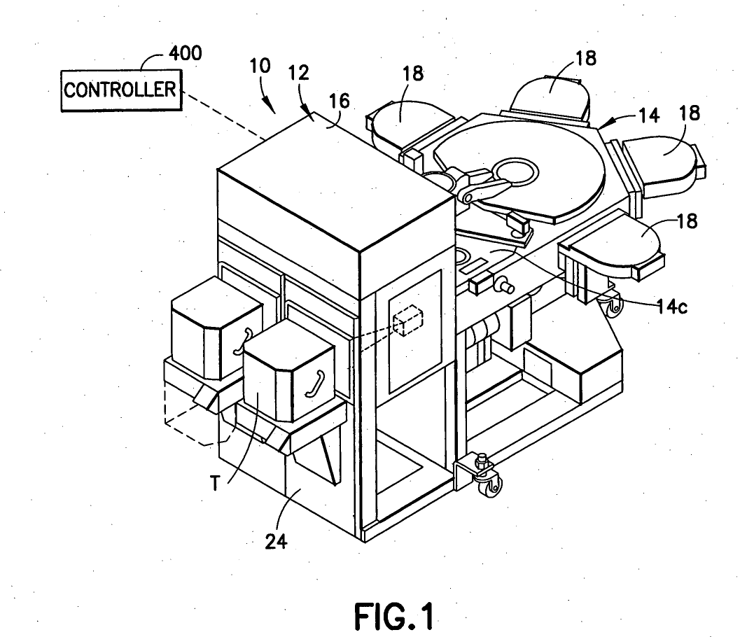

Referring to FIG. 1, there is shown a perspective view of a substrate processing apparatus 10 incorporating features of the present invention is illustrated. Although the present invention will be described with reference to the embodiment shown in the drawings, it should be understood that the present invention can be embodied in many alternate forms of embodiments. In addition, any suitable size, shape or type of elements or materials could be used.

In the embodiment illustrated in FIG. 1, the apparatus 10 has been shown, for example purposes only, as having a representative substrate batch processing tool configuration. In alternate embodiments, the substrate processing apparatus may have any other suitable configuration, as the features of the present invention, as will be described in greater detail below, are equally applicable to any substrate processing tool configuration including tools for individual substrate processing. The apparatus 10 may be capable of handling and processing any desired type of flat panel or substrate such as 200 mm or 300 mm semiconductor wafers, semiconductor packaging substrates (e.g. high density interconnects), semiconductor manufacturing process imaging plates (e.g. masks or reticles), and substrates for flat panel displays. The apparatus 10 may generally comprise a front section 12 and a rear section 14. The term front is used here for convenience to identify an exemplary frame of reference, and in alternate embodiments the front of the apparatus may be established on any desired side of the apparatus. The front section 12 has a system providing an interface allowing the importation of substrates from the FAB into the interior of the apparatus 10. The front section 12 also generally has a housing 16 and automation components located in the housing handling substrates between the rear section 14 and the front section interface to the exterior. The rear section 14 is connected to the housing 16 of the front section. The rear section 14 of the apparatus may have a controlled atmosphere (e.g. vacuum, inert gas), and generally comprises a processing system for processing substrates. For example, the rear section may generally include a central transport chamber, with substrate transport device, and peripheral processing modules or process chambers 18 for performing desired manufacturing processes to substrates within the apparatus (e.g. etching, material deposition, cleaning, baking, inspecting, etc.). Substrates may be transported, within the FAB, to the processing apparatus 10 in containers T. The containers T may be positioned on or in proximity to the front section interface. From the containers, the substrates may be brought through the interface into the front section 12 using automation components in the front section. The substrates may then be transported, via load locks, to the atmospherically controlled rear section for processing in one or more of the processing modules. Processed substrates may then be returned, in a substantially, reversed manner, to the front section 12 and then to the transport containers T for removal.

The front section 12, which may otherwise be referred to as an environmental front end module or EFEM, may have a shell or casing defining a protected environment, or mini-environment where substrates may be accessed and handled with minimum potential for contamination between the transport containers T, used to transport the substrates within the FAB, and the load locks 24 providing entry to the controlled atmosphere in the rear processing section 14. Load ports or load port modules 24 are located on one or more of the sides of the front section providing the interface between the front section and FAB. The load port modules may have closable ports forming a closable interface between the EFEM interior and exterior. As seen in FIG. 1, the load port modules may have a support area for a substrate transport container T. A secondary holding area may also be provided under the support area, where transport containers may be temporarily buffered. The transport container support area may allow automated movement of the transport container T supported thereon to a final or docked position. Proper placement of the transport container T on the support area, before movement, may be detected and verified with detection switches integral to the cover or casing of the support area. Positive engagement or lock down, again prior to movement, of the transport container, in the load port support area may be achieved with actuated clamps of the load port. Transport of the transport container on the support area of the load port to the final or docked position (i.e. the position of the transport container proximate to the port through which substrates are transported between the transport container and the interior of the EFEM casing interior) may be detected by a touchless (i.e. contamination free) position sensor. In cooperation with the apparatus control system, depicted by the dotted line box marked “controller”, the position sensor operates to repeatedly establish the transport container docked position with minimal clearance between container and load port frame despite the tolerance variation in the dimensions of the transport container. Also, pinch detection during automated movement of the transport container may be provided by one or more sensors monitoring current to the transport motors. The pinch sensors are connected to the control system that has programming to automatically stop and reverse direction of travel upon receiving an appropriate signal from the pinch sensors. The port door, of the load port module, may engage the transport container when in the docked position in order to open the transport container while also opening the access port in the load port frame, to provide access to substrates within the transport container as well as access for transporting the substrates between the container and EFEM interior. Engagement between the port door and transport container may be effected by independently operable keys with independent sensors for detecting improper engagement or operation as will be described below. The port door may be mounted on a resiliently flexible mount stably supporting the door while providing the door with sufficient range of motion when opening to clear the access port frame or other load port module structure obstructions. Additional movement of the door to open the port for substrate transport may be accomplished with a drive that is pivoted into a position so that door movement, when opening/closing, is substantially parallel with the face of the EFEM. The load port module may have a sensor for detecting the presence of substrates inside the transport container. The sensor is actuated to access the transport container interior and moved to scan the interior of the transport container simultaneous with the movement of the port door to open the access port. The sensor is connected to the control system to identify presence, position and orientation of the substrates inside the transport container. Another feature is that the load port module may be an intelligent load port module. The load port may have an integrated user interface, communicably connected to the control system, controllers and sensors, allowing a user to locally input data, information, and programming for operation and health status monitoring of the processing apparatus. The user interface may have a graphics display integrated to the load port module capable of graphically displaying information regarding desired operational status and health status data of the apparatus, as well as any desired accessible information available in the control system. The user interface may have suitable I/O ports for connecting peripheral devices, such as a teach pendant, and allowing bidirectional communication with the peripheral devices when connected to the user interface. The load port module may further be provided with a camera located for viewing motions of desired automation components. The camera may be communicably connected to the control system, which is suitably programmed to identify from the camera signal errors in the motions of the automation components. The display of the user interface may display the view frames or video stream generated by the camera.

The term process module, as used herein, means a module of any type through which a substrate may be loaded into or unloaded from, pass or within which a substrate may reside. For example, the term specifically includes process chambers in which chemical or physical processing can take place on the substrate. It also specifically includes load locks, load ports, transfer chambers and similar apparatus. It also includes any part, device module, subsystem, system etc. involving substrates.

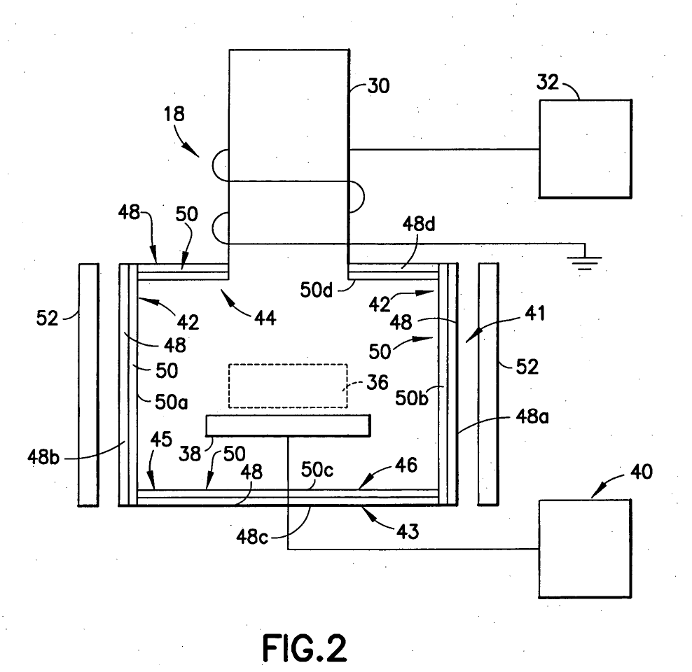

A first exemplary process module in accordance with one exemplary embodiment is shown in FIG. 2. Substrates are commonly loaded into and unloaded from a process module, including the process chamber shown in FIG. 2, through an opening or door or the like by a substrate transport device or arm such as the one described in the central transport chamber described in conjunction with FIG. 1. Substrates may be loaded into and unloaded from process modules in any other suitable manner such as by openings or doors in the rear, top, bottom, etc. of the process module and by any suitable device such as the transport device described above, an auxiliary transport arm or manually.

FIG. 2 very generally depicts a representative process module 18 or chamber, which is shown as a chemical vapor deposition apparatus that can be used in processing a substrate. In chemical vapor deposition a gas containing a metal insulator chemistry is sprayed on the substrate. Gases react on the heated substrate surface forming a thin film of solid material. Energy sources such as heat and radio frequency (rf) power are used alone or in combination to achieve this reaction. The chemical vapor deposited films range in thickness from a small fraction of a micron to larger thickness and must be deposited with extreme uniformity across the substrate. The process chamber 18 may be an interactively coupled plasma reactor with a dielectric discharge chamber 30 and an rf power source. A substrate 36 is placed (such as by a substrate transport device passing the substrate through a door between the process chamber and the central transport chamber) on pedestal 38, which is connected to an rf bias source 40. The chamber enclosure 41 in this exemplary embodiment has sidewalls 42, bottom 46 and ceiling 44 and has adjacent magnets 52 (see FIG. 2). The sidewalls, bottom and ceiling are each constructed of adjoining layers, 48 and 50, each made of different types of materials. For example, as will be described in greater detail below, a layer of a corrosive-retardant material 50 may be used in sidewalls, bottom and ceiling facing the interior 45 of the chamber. Another material 48, different from material 50, may be used for an adjacent layer in the sidewalls, bottom and ceiling, located on the side of the corrosive-resistant material layer and facing the exterior 43 of the chamber enclosure 41. In the embodiment shown, the sidewalls 43 42, bottom 46 and ceiling 44 of the chamber enclosure are a composite multi-layered member, though, in alternate embodiments, the chamber enclosure may be multi-layered members. In the embodiment shown in FIG. 2, the sidewall, bottom and ceiling have two different layers, but in alternative embodiments, one or more of the sidewalls, bottom and ceiling may have more than two layers of different material.

The corrosive retardant material and the other or second material layers are joined together, as described below, whereby the amount of corrosive-retardant material can be reduced, especially when processing large panels in the chamber. The corrosive retardant material can be any suitable material which functions as a corrosion retardant material and depends upon the corrosive atmosphere or material present in the environment of the processing module 18. For example, the corrosive-retardant material can be aluminum, aluminum alloys and other suitable materials. In the embodiment shown, the corrosion-retardant or corrosion-resistant material layers 50 of the sidewalls, bottom and ceiling may be made from the same type of corrosion-retardant material. In alternative embodiments, different types of corrosion-resistant can be used for different corrosion-retardant material of the sidewalls (50a, 50b), bottom (50c) and ceiling (50d). Similarly, the other layers, 48, in the sidewalls (48a, 48b), bottom (48c) and ceiling (48d) may be of the same material or of different types of materials.

As noted before, the second material 48 may not have to be corrosion-retardant and can be made of less costly material such as steel, steel alloys, stainless steel or other suitable materials such as plastic, ceramic, composite or other non-metallic materials. In the exemplary embodiment, a non-magnetic steel, such as non-metallic metals or non-metallic stainless steel, may be used for the other or second layers (48a, 48b, 48c, 48d) of the enclosure sidewalls, bottom and ceiling. As may be realized, the corrosion-retardant material 50 and the other or second (for example, noncorrosion-retardant) material 48, respectively, for the layers 50a, 50b, 50c and 50d and layers 48a, 48b, 48c and 48d may have any desired characteristic and still retain the corrosion-retardant ability. By way of example, enclosure portions (for example, bottom) where higher strength may be desired, may have another or second material layer 48c made of higher strength material, yet maintain corrosion-retardant property from the corrosion-retardant layer 48c.

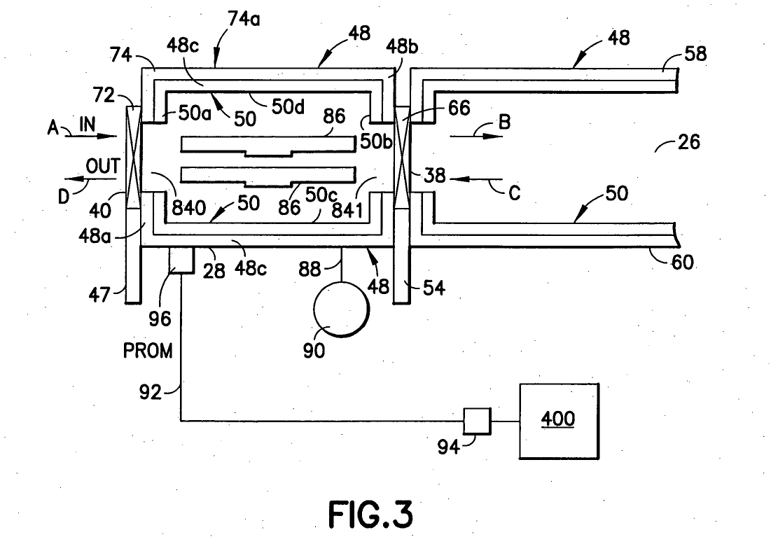

Another exemplary process module is used is shown in FIG. 3. FIG. 3 depicts a representative load lock device that can be used in processing a substrate. FIG. 3, illustrates a cross-section of a representative load lock. port 24 shown as module 74 installed therein. Load lock module 74 in this embodiment is a passive pass-through load lock. The load lock module has outer and inner entry ports 84O, 84I. When installed in apparatus 10, the outer entry port 84O of module 74 is generally aligned with the corresponding opening 40 in the front wall 47, and the inner port 84I is generally aligned with the corresponding opening 38 and the internal wall 54 of the back section 14. In the embodiment shown, load lock module 74 includes two stationary substrate support shelves 86 for supporting substrates in the load lock module, though the load lock module may have any suitable number of support shelves. The load lock module 74 also includes all appropriate plumbing 88 and systems 90 for roughing the load lock to substantially the same vacuum condition as the central chamber 26 and for restoring the load lock to atmospheric conditions present in the front section 12. By way of example, the plumbing 88 may include piping/tubing (not shown) removably connected, such as by using a union or any other suitable mechanical fitting, to the high vacuum pump (not shown) used for providing the central chamber 26 with the vacuum condition. A suitable valve (not shown) in the plumbing 88 may be used to isolate the load lock 74 from the vacuum pump. The valve may be remotely operated by the controller 400. Otherwise a roughing only pump may be included in the systems 90 of load lock module 74, which pump is activated by controller 400 to rough-out the load lock. The load lock plumbing 88 may further have an intake pipe and valve (not shown) for reintroducing, under control by controller 400, atmospheric conditions into the load lock.

The controller 400 may control slot valves 66 (located in both inner and outer ports 84I 840) to isolate the central chamber 26 from the load lock module 74 and this load lock module from its EFEM.

The chamber enclosure 74e on the load lock module 74 is generally similar to the enclosure 41 of chamber 18 described before and shown in FIG. 2. Similar portions are similarly numbered. In this embodiment, the sidewalls, bottom and ceiling of chamber enclosure 74 are also composite multi-layered members having multiple adjoining layers 48 and 50. In this embodiment, one layer 50 can be of suitable corrosive-retardant or corrosive-resistant material (for example, 50a, 50b, 50c and 50d) and another adjoining layer of another or second material 48 can be of a suitable material (for example, 48a, 48b, 48c and 48d) different from the corrosive-retardant material type 50. The other or second type of material 48 (layers 48a, 48b, 48c and 48d) may or may not be of a corrosive-retardant material as described before with respect to material 50. The corrosion retardant material can be any suitable material, which defers, retards, reduces, or eliminates the corrosive process. As noted before, the selection of material or alloy or processed material may be based on the nature of the harsh environment to which the module is exposed. In many applications, aluminum, aluminum alloys, and aluminum with coatings have been suitable. The other or second material may not be corrosive-tetardant and therefore will most likely be less expensive. The second material can be any suitable material such as steel(s); for example, carbon steel or stainless steel, or non-metallic material such as plastic or composite.

The layers of corrosive-retardant material and the other or second material (such layers 50a, 50b, 50c 50d and layers 48a, 48b, 48c and 48d, respectively) can be joined together in any suitable fashion. For example, the joining can be accomplished by mechanical fasteners, for example., using bolts (not shown), or by chemical bonding, molecular bonding, or by welding, explosive welding. Explosive welding results in a substantially seamless interface between layers metallurgical and this is desirable in a vacuum or corrosive environment. The joining process for manufacturing a component part, such as any section of the chamber, enclosure 41,74e is generally done by providing a layer of first corrosive-retardant material and joining another layer of the second material to the corrosive retardant material later.

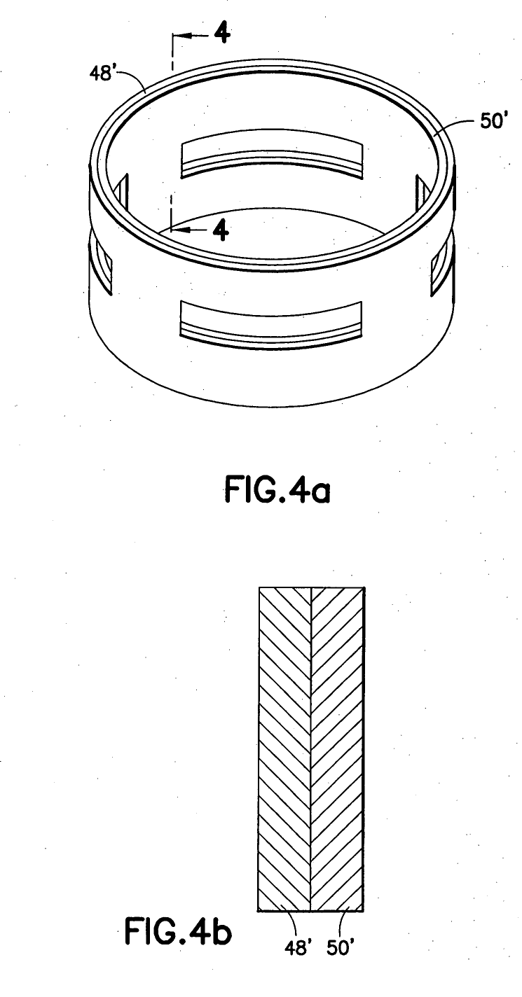

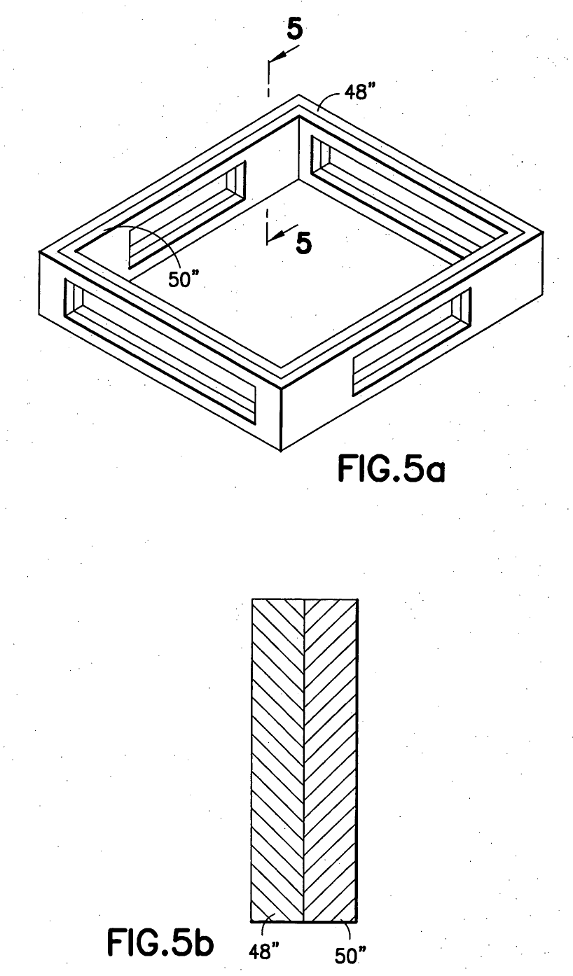

FIGS. 4a, 4b, 5a and 5b illustrate typical embodiments of the composite, multi-layered sidewall of enclosure 41 or enclosure 74e such as described in FIGS. 2 and 3. The enclosure shown has two different types of materials joined together, one of the materials, 50, being a corrosive-retardant material forming a module interior face disposed to be subjected to the interior atmosphere of the module, and the other material, 48, being located on the side of the corrosive-retardant material to define a module outer face opposite the interior face. FIG. 4ashows an enclosure, such as a vertical wall section similar to walls 42 in FIG. 2 for the chamber 41 or process module 18 in a generally circular or curved configuration, particularly for use in processing wafers. FIG. 4b shows a cross-section view of the two materials, for example, corrosion material such as aluminum referred to as “A” which faces the interior of the module and material “B’ which faces away from the interior of the module. In this embodiment, material A, shown more clearly in FIG. 4b, may be any suitable corrosive retardant material such as aluminum. Material B, on the other hand, may be a less expensive material such as steel or non-metallic material. Material B is adjacent material A.

The composite, multi-layered wall of a process module enclosure shown in FIG. 4a can be made in any suitable fashion. In one embodiment of the manufacturing process, the two layers 48′ and 50′ can be formed into a circular configuration and the corrosive-retardant layer placed inside the other layer and joined together by welding. Layers 48′ and 50′, for example, may be manufactured to size as individual, circular components such as by cutting stock to suitable size, shaping the stock into a tubular configuration and then butting and joining the ends together to form a circular configuration. Other manufacturing techniques may also be employed to form each layer 48′ and 50′, such as machining, extruding, forging, casting, etc., and then joining the two layers, 48′ and 50′, together in any suitable fashion such as by mechanical fastening, bonding, welding, etc. to form the sidewall of the enclosure. Desired features, such as holes/openings, ribs, flanges, desired in the final manufactured module, may be formed into the layers prior to joining, or may be added by suitable forming process after attachment of the adjoining layers to each other. In alternate embodiments, layers 48′ and 50′ each may be made up of several parts which may be joined together to form a whole layer in a circular configuration before or while being joined to the other layer to form the composite, multi-layered sidewall of the enclosure. In another alternative, multi-layered parts of layers 48′ and 50′ may be formed and joined together to form the complete composite, multi-layered sidewall of the enclosure in a circular configuration.

FIGS. 5a and 5b illustrate another embodiment of the sidewall of an enclosure, which may be used in a process chamber such as those shown in FIGS. 2 or 3. FIG. 5a shows a sidewall of an enclosure for a process module in a generally rectangular or square configuration, particularly for use in processing flat panels. FIG. 5b shows the two materials, material “A” which is corrosion-retardant and faces the inner portion of the module and material “B” which is the outer face of the sidewall. In this embodiment as previously described in FIGS. 4a and 4b, material A, shown more clearly in FIG. 4b, may be any suitable corrosive-retardant material such as aluminum. Material B, on the other hand, may be a less expensive material such as steel, or non-metallic material such as plastic. Material B is adjacent material A and faces away from the inner portion of the module. In this embodiment, the configuration of the sidewall includes substantially flat sides joined to form square or rectangular shape in this embodiment. In alternate embodiments, the- sidewall may have any desired number of flat sides or portions. The flat sides of the wall readily facilitate each layer to be made of multiple component parts from substantially flat stock that is cut to size and may be butted and joined together to form each layer 48″ and 50″. Layer 50″ can be placed inside of layer 48″ and the two joined together such by welding to form the sidewall of the enclosure. Alternative manufacturing techniques similar to those discussed previously with FIGS. 4a and 4b can also be employed in this embodiment.

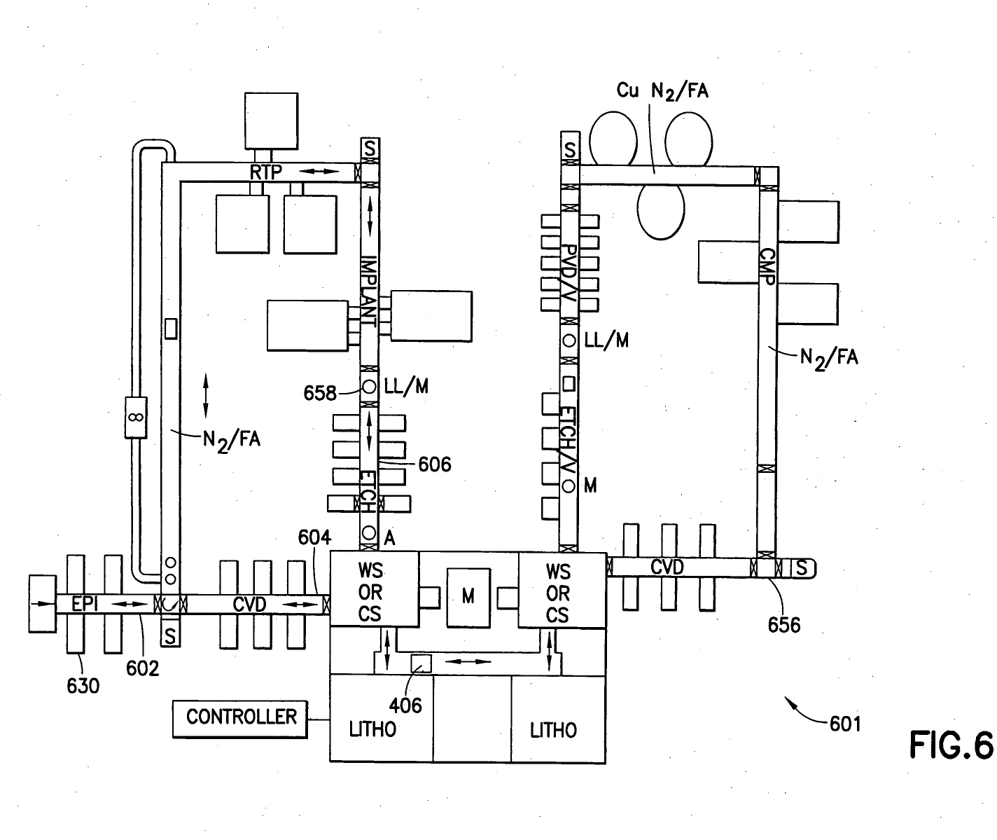

FIG. 6 shows another embodiment of an exemplary substrate processing apparatus as fabrication facility 601, having a linear chamber(s) formed of one or more modules similar to modules/module enclosures described before and shown in FIGS. 2-5. Examples of apparatus similar to apparatus 601 are disclosed in U.S. patent application Ser. No. 10/624,987, filed on 22 Jul. 2003, and U.S. patent application Ser. No. 10/962,787, filed on 9 Oct. 2004, both applications being incorporated by reference herein in their entirety. In this embodiment, carts 406 transport substrates or wafers through process steps within the fabrication facility 601 through transport chambers, for example, 602, 604, 606 and 608. The processes in the chambers may include, for example, epitaxial silicon 630 as well as other processes such as dielectric deposition, photolithography, etching, ion implantation, rapid thermal processing, metrology, metal deposition, electroplating, chemical mechanical polishing, etc. Load locks 656 and other apparatus such as transfer chambers may be used to transition between one environment and another; for example between vacuum and nitrogen or argon. Accordingly, the chamber(s) of apparatus 601 may hold corrosive atmospheres or vacuum. Chamber modules, similar to process modules 41, 74, described before may be joined, serially in any desired arrangement, to one another to form the chamber(s) and processing modules of apparatus 601.

It should be understood that the foregoing description is only illustrative of the invention. Various alternatives and modifications can be devised by those skilled in the art without departing from the invention. Accordingly, the present invention is intended to embrace all such alternatives, modifications and variances, which fall within the scope of the appended claims.

What is claimed is:

1. A process module for processing substrates comprising two different types of materials, one of the materials being a corrosive-retardant material forming a module interior face disposed to be subjected to the interior atmosphere in the module, and another of the materials being located on the side of the corrosive-retardant material to define a module outer face opposite the interior face, wherein the corrosive-retardant material and the other material are joined together.

2. The process module according to claim 1 wherein the corrosive-retardant material and the other material are adjacent one another.

3. The process module according to claim 1 wherein the amount of corrosive-retardant in the process module material can be reduced.

4. The process module according to claim 1 wherein at least one of the modular faces is substantially flat.

5. The process module according to claim 1 wherein both of the modular faces are substantially flat.

6. The process module according to claim 1 wherein at least one of the modular faces is curved.

7. The process module according to claim 1 wherein both modular faces are curved.

8. The process module according to claim 1 wherein the corrosion-retardant material is aluminum.

9. The process module according to claim 1 wherein the other material is steel, and is located adjacent the corrosion-retardant material.

10. The process module according to claim 1 wherein the other material is non-metallic, and is located adjacent the corrosion-retardant material.

11. The process module according to claim 1 wherein the corrosion-retardant material and other material are joined together by welding.

12. The process module according to claim 1 wherein the corrosion-resistant material and the other material are fastened together.

13. The process module according to claim 1 wherein the process module is a load lock module.

14. The process module according to claim 1 wherein the process module carries out chemical processing on the substrates.

15. The process module according to claim 1 wherein the process module carries out physical processing on the substrates.

16. The process module according to claim 1 wherein the process module is a transport chamber.

17. A substrate processing apparatus comprising:
a transfer apparatus for transferring substrates in the processing apparatus, and
a process chamber enclosure connected to the transfer apparatus and having at least one wall formed from joined layers of different types of materials, at least one layer being of a corrosive-retardant material, and forming an inner face of the enclosure subjected to the interior atmosphere of the enclosure and, another layer being of a different material from the corrosive-retardant material, opposite the interior face, the other layer forming an outer face of the enclosure.

18. The apparatus in accordance with claim 17 wherein the different material of the other layer is selected so that when joined together with the at least one layer, the amount of corrosive-retardant material can be reduced.

19. A method of making part of a substrate process module enclosure capable of holding a corrosive environment therein, the method comprising providing a first corrosive-retardant material and joining another material different from the corrosive-retardant material to the corrosive-retardant material.

20. The method of claim 19 wherein the corrosive-retardant material is aluminum.

21. The method of claim 19 wherein the other material is steel.

22. The method of claim 19 wherein the other material is non-metallic.

23. The method of claim 19 wherein the corrosive-retardant and second materials are joined by welding.

24. The method of claim 19 wherein the corrosive-retardant and second materials are joined by molecular bonding.
